(19) United States
(12) Patent Application Publication
(10) Pub. No.: US 2025/0345748 A1
(43) Pub. Date: Nov. 13, 2025

(54) MATERIALS AND METHODS FOR ENHANCED CARBON REMOVAL EFFICIENCY IN CO2 CAPTURE PROCESS USING NANO-BUBBLING TECHNOLOGY

(71) Applicant: Halliburton Energy Services, Inc., Houston, TX (US)

(72) Inventors: Zhiwei Yue, Sugar Land, TX (US); Chunli Li, The Woodlands, TX (US); Ronald Bosch, Houston, TX (US)

(21) Appl. No.: 18/659,640

(22) Filed: May 9, 2024

(51) Int. Cl. B01D 53/78; B01D 53/14; B01D 53/18; B01D 53/34; B01D 53/62

(52) U.S. Cl. CPC B01D 53/78; B01D 53/1412; B01D 53/1418; B01D 53/1475; B01D 53/18; B01D 53/346; B01D 53/62; B01D 2251/306; B01D 2257/504; B01D 2258/0283

(57) ABSTRACT

Described herein are methods and materials for increasing the scavenging efficiency of carbon dioxide, such as produced during combustion operations. The gas may be initially collected and tested to determine the concentration of gas within the gas mixtures. The gas mixture, after testing, may then be passed through a bubble tower reactor that includes a concentration of scavenging material to scavenge CO₂ gas from the gas mixture and generate a cleaner gas and a carbon-rich liquid after treatment.

### TECHNICAL FIELD

The present disclosure relates generally to oilfield operations and, more particularly (although not necessarily exclusively), to materials and methods for improving gas scavenging efficiency for use in wellbore, production, or combustion operations.

### BACKGROUND

Emissions greenhouse gases have increased since large-scale industrialization began. Concentrations of CO₂ in the atmosphere are naturally regulated by many processes that are part of the global carbon cycle, however it may be beneficial to reduce non-naturally occurring CO₂ gas production. Methods for reducing CO₂ in the environment may include scavenging CO₂ from gas, or sequestration and compaction of CO₂.

### BRIEF DESCRIPTION OF THE DRAWINGS

FIG. 1 is a cross sectional view of a well system for oilfield operations, including drilling in subterranean formations where CO₂ capture processes may be implemented according to examples of the present disclosure.

FIG. 2 is a block diagram of a method for treating CO₂ captured or collected as a biproduct during oilfield operations according to one example of the present disclosure.

FIG. 3 is an example diagram of a bubble tower reactor configured for treating gas collected or captured during oilfield operations according to one example of the present disclosure.

FIG. 4 is an example schematic of the bubbles produced in a bubble tower reactor according to one example of the present disclosure.

### DETAILED DESCRIPTION

Certain aspects and examples of the present disclosure involve materials and methods for improving the efficiency of CO₂ scavenging using nano-bubblers in liquid towers and other scavenging systems. For example, other scavenging methods may be employed such as bubble tower reactors or liquid direct air capture (LDAC). Oilfield operations (e.g., drilling, completions, and production operations in the oil field) as well as everyday industrial plants, waste-water, coal power plants, or landfills can produce large quantities of CO₂ gas. LDAC style platforms may employ a potassium hydroxide solution in a liquid that may scavenge CO₂ from the air. The scavenged air may generate a carbonate salt that may be further processed, such as to generate a solid mineral including CO₂ or for producing pure CO₂ gas. In LDAC systems, the contact time between molecules of CO₂ and potassium hydroxide solution may be a rate limiting step and impacts the efficiency of capture. Thus, methods for increasing contact time and surface area described herein may be used to increase the efficiency of CO₂ removal.

Liquid based methods for removing CO₂ from emissions generated during production gas transportation commonly utilizes potassium hydroxide, and other scavenging materials. In solid direct air collection methods, air is forced into a collector where the CO₂ may be captured by a filter. Upon reaching a saturated state, the collector unit may be closed and subsequently heated to release captured CO₂. Solid air methods may be more expensive due to the less efficient capture method of CO₂. Additionally, the solid method may be more energy-intensive and may be more labor intensive as the absorbent may require consistent replacement. In an alternate method a liquid based direct air capture utilizing methods and materials described herein may be more efficient, consume less scavenging material, and may allow for a more compact facility thus reducing cost.

Removal of CO₂ from the emissions generated during oilfield operations, production operations, or other combustion generated during the above-mentioned methods may be of interest for environmental reasons. For example, equipment used during oil well drilling and production operations may produce, as a byproduct, exhaust gasses that include CO₂ gas. The exhaust gasses may be treated to remove CO₂ providing a gas mixture will less or no CO₂. In some embodiments, CO₂ gas may be scavenged from the gascous mixture using bubble tower reactors or liquid direct air contactors (L-DAC).

In commonly used reactors, the efficiency of removal may be impacted by the surface area of the bubbles, the concentration of the solution, and bubble path time (contact time). For example, in environments where the bubbles are heterogenous, the differences in size distribution of the gas bubbles may lead to inefficient removal of harmful gas from the gas mixture. Additionally, the larger the bubble, the faster they rise through the solution thereby decreasing contact time with the scavenging material. In an alternate scenario, the concentration of scavenging material within the solution may need to be increased to account for the non-uniformity of the bubbles. The increase of the scavenging material, for example alkali metal hydroxide-based compounds in high concentrations, may be harmful to the environment.

In contrast, embodiments of the present disclosure can increase efficiency of scavenging and allow for systematic alterations to the scavenging methods to alter the scavenging process when applied to different environments. For example, the amount, size, pressure, and gas content of bubbles produced within the tower can be controlled to adjust scavenging. Additionally, the solution used for scavenging can be controlled such that the concentration of the alkali metal hydroxide or other scavenging chemical used can be changed, allowing for controlling of chemical moieties. This can allow for a more efficient, cost effective, and cleaner removal of various gases within the gas mixture. For example, the concentration of the alkali metal hydroxide may be up to 1 mol/L. Embodiments of the present disclosure can also be used to remove other gases in addition to CO₂ from gas released or produced during drilling and production operations by changing the scavenging material and the input gas passed through the solution. In some embodiments, the reactors or capturing facility may be reduced in size as compared to common methods for capturing CO₂ while simultaneously maintaining the same capturing capability of CO₂. The reduced size may translate to a lower capital cost.

In a particular example, the methods disclosed herein may include using a nano-bubbler for the sparger in a contact tower or for use in liquid droplet direct injection into flow lines, pipelines, or gas lines. The use of a nano-bubbler may increase surface area of the gas bubbles in the solution because the generated nano-bubbles has a large surface area when compared to their volume. The use of the nano-bubbler may increase contact time and surface area of the gas inside of the tower. In some embodiments, the methods described herein may be employed on alternate less CO₂-rich gas streams.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

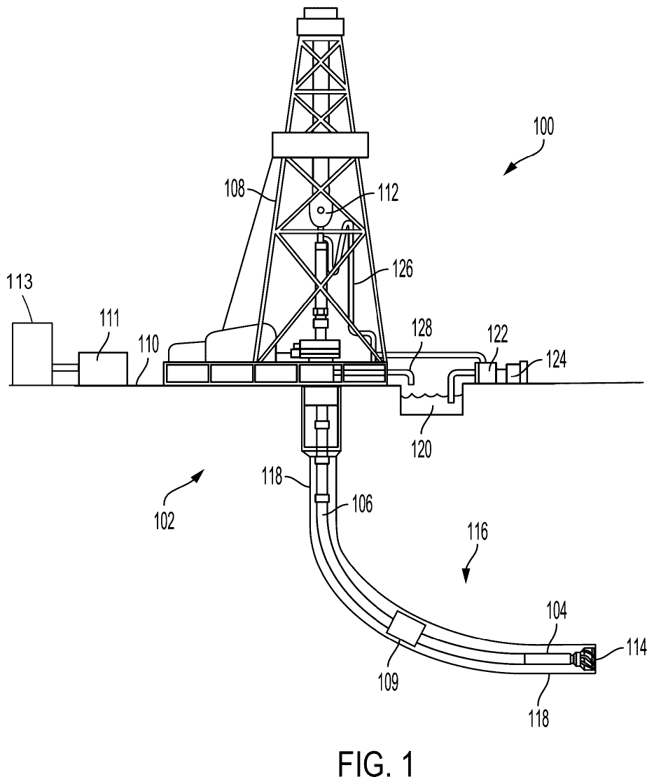

FIG. 1 is a cross sectional view of a well system for drilling in a subterranean formation whereby CO₂ may be produced as a byproduct of drilling operations, for example CO₂ may be present in the exhaust gas of equipment used during oilfield operations including drilling, according to one example of the present disclosure. A wellbore 118 used to extract hydrocarbons may be created by drilling into a subterranean formation 102. The well system 100 may include a bottom hole assembly (BHA) 104 positioned or otherwise arranged at the bottom of a drill string 106 extended into the subterranean formation 102 from a derrick 108 arranged at the surface 110. The derrick 108 includes a kelly 112 used to lower and raise the drill string 106. The BHA 104 may include a drill bit 114 operatively coupled to a tool string 116, which may be moved axially within the drilled wellbore 118 as attached to the drill string 106. The combination of any support structure (in this example, derrick 108), any motors, electrical equipment, and support for the drill string 106 and tool string 116 may be referred to herein as a drilling arrangement.

During operation, the drill bit 114 can penetrate the subterranean formation 102 to create the wellbore 118 where gas may be located. The BHA 104 can provide control of the drill bit 114 as the drill bit 115 advances into the subterranean formation 102. The combination of the BHA 104 and drill bit 114 can be referred to as the drilling tool. Fluid or “drilling mud” from a mud tank 120 may be pumped downhole using a mud pump 122 powered by an adjacent power source, such as a prime mover or motor 124. Alternatively, assemblies may be in place for pumping gas out of the subterranean formation through pipes and lines into storage tanks or holding tanks to be processed. In some embodiments, systems may be in place for pumping steam down a formation to stimulate a formation for hydrocarbon production. During such process CO₂ gas may be generated as described above. In such scenarios, gas generated, or collected during operations may be pumped to the surface and further routed to alternate locations for scavenging the CO₂ from the gas.

In some embodiments, the operation site includes a bubble reactor tower 111 and system 113 for collecting the gas from the operations. For example, through pipes and systems attached to the derrick 108, such as pipes running parallel or in combination with the pipes 126 for pumping mud downhole. The flow lines may be in fluid and gas communication with the bubble reactor tower 111. In some embodiments, the flow lines for gas collection may be in fluid connection with storage tanks for holding the gas. Alternatively, the gas may be collected from the production operations and facilities generating emissions. The emissions may have high concentrations of CO₂ gas contained in the exhausts and thus, the emissions produced during the well operations may be collected and scavenged using the methods described herein. The gas may be subsequently stored in gas cylinders for collecting the gas and may be used in the bubble tower reactor 111 and the system 113 for collecting the gas from the operations. One skilled in the art may understand that the methods disclosed herein, while used in examples for oil well drilling, may be employed for use in any operation and method wherein CO₂-containing gas is collected or produced.

In some embodiments, the methods described herein may be used at landfills, waste-water treatment plants, combustion facilities,, and other industrialized processing facilities that include facilities emitting large quantities of CO₂ gas into the environment. For example, other sources that may have high concentrations of CO₂ can include aluminum production plants, gas turbine exhaust, fired boiler of oil refinery and petrochemical plant, natural gas fired boilers, oil-fired boilers, coal-fired boilers, IGCC syngas turbine, hydrogen production, steel production, cement processing and combustion operations. The facilities and sources of CO₂ may be processed via methods described herein for removing CO₂ from the produced gas emissions.

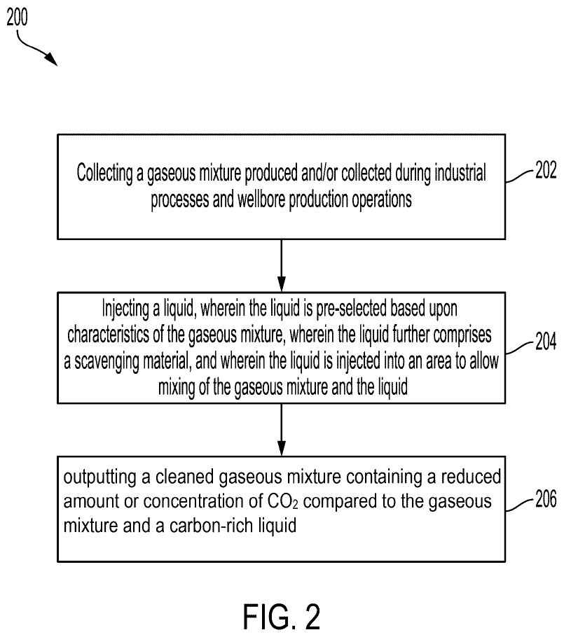

FIG. 2 is a block diagram of a process 200 for treating gas captured or collected as a byproduct from the equipment used in oilfield operations according to one example of the present disclosure. At block 202, the gas mixture produced by the operations performed for oil extraction may be collected. In some embodiments, the collected gascous mixture may be from hydrocarbon production operations, or combustion operations, such as where the gaseous mixture includes CO₂. The collection process may utilize pipes or tubing disposed within the wellbore and connected to surface equipment. The surface equipment may include holding tanks that may store the gaseous mixture. In some embodiments, the gas may be collected or routed from other industrial processes to the reactor location. For example, the exhaust from production operation plants may include large quantities of CO₂ that may be collected and injected into a reactor. In some embodiments, the gaseous mixture may be disposed into cylinders and transported off site for treatment. In an alternate embodiment, the gas cylinders containing the CO₂ gas may be treated on site in bubble tower reactors. Alternative methods for treating the CO₂ gaseous mixtures may be employed. For example, the gas may be treated using an L-DAC system as described above. In certain embodiments, the scavenging may occur via use of a nanobubble generating sparger. For example, the gaseous mixture may be injected into a liquid as a plurality of nanobubbles. This liquid may comprise a CO₂ scavenging material that interacts with the nanobubbles to remove CO₂ from the nanobubbles.

At block 204, a bubble tower system, as described further below, is filled with a liquid. The liquid may include a concentration of a scavenging material. In some embodiments, the concentration of the scavenging material is determined based upon the concentration of CO₂ gas in the gaseous mixture. For example, the higher the concentration of CO₂ in the gas, the higher the concentration of scavenging material may be dissolved in the liquid. In some embodiments, the concentration of CO₂ scavenging material may be from 1 wt. % to 30 wt. % by weight of monoethanolamine (MAE) aqueous solution. In some embodiments, the liquid may be a water or a brine. In embodiments including brine, the salinity of the brine may be controlled. For example, the salinity of the brine may be from 1 part per thousand (ppt) to 50 ppt. In some embodiments, the temperature of the liquid inside the bubble tower reactor may also be controlled. For example, the temperature may be maintained at a temperature range from 50° F. up to 300° F., or from 50° F. to 100° F., from 100° F. to 150° F., from 150° F. to 200° F., from 200° F. to 250° F., or from 250° F. to 300° F. In some embodiments, gas within the gas mixture may also be controlled.

The injection into the bubble tower reactor may be in a continuous flow or may be performed in a batch operation. During a batch operation, the liquid is injected into the bubble tower reactor until at least 75% of the tower is filled with liquid, for example. The gas mixture is injected into the tower at a constant rate until the liquid is spent of the scavenging material. For example, when at least 80% by volume of the scavenging material has been converted, the injection of gas is shut off and the solution from the tank is released through pipelines and into a holding tank. The tower may then be refilled with a new batch of liquid and the process may be repeated. The process may be repeated until the gas collected from the subterranean formation has all been passed through a bubble tower reactor to remove at least 70% of the CO₂ gas. For example, the gas is treated in the bubble tower reactor until at least 70% CO₂ is removed, at least 75% CO₂ is removed, at least 80% CO₂ is removed, at least 85% CO₂ gas is removed, or at least 90% CO₂ gas is removed. In a continuous flow system, the liquid containing the scavenging material is injected via droplet spray injection, into the pipeline or flowline containing the gas mixture.

At block 206, the cleaned gas mixture containing a reduced amount or concentration of CO₂ compared to the gaseous mixture and a carbon-rich liquid may be output. For example, the gas, after passing through the system may be diverted, via pipelines, to a storage containers. In some embodiments, the storage containers may be cylinders. The gas collected may be tested by using an CO₂ analyzer, absorption spectroscopy, electrochemical sensor cell, colorimetric methods, or gas chromatography methods. For example, the gas may be tested to determine the concentration of CO₂. For example, if the concentration is sufficiently low, scavenging may be considered completed and/or the gas may be considered safe. If the concentration is high, the gas may be treated a second time or repeated until the concentration of CO₂ is at or below a threshold limit, such as less than 1.0% based on total volume of gas.

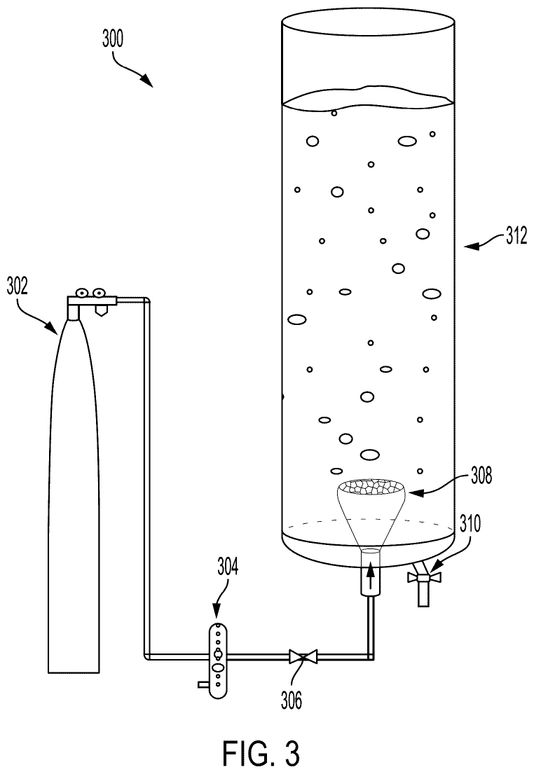

FIG. 3 is an example diagram of a bubble tower reactor for treating gas containing CO₂ that is collected and directed through the tower according to one example of the present disclosure. One skilled in the art may understand that while a bubble tower depicted in FIG. 3 may be used for removing a gas from a mixture of gases, it is employed here merely as an example and should not limit the scope of the present disclosure. Other reactor types may be used for removing CO₂ from a gas mixture. A bubble tower reactor system may include at least a flow meter 304, a control valve 306, a tank 312, a sparger 308, and an exit valve 310. In some embodiments, the system may include alternate components or configurations that may be used for further improving the efficiency of removal. In some embodiments, the flow meter 304 may be positioned in liquid communication with the pipeline flowing from the gas collection reservoir 302 to the control valve 304. In some embodiments, the gas collection reservoir 302 may be a gas cylinder, a direct injection line from gas collected during the oilfield operations, or a flowline from a gas source that has been initially recycled. The gas collection reservoir may be attached to pumps that may aid in pumping the gas from the collection reservoir to the tank/tower.

The control valve 306 may be used for changing the flow rate of gas from the gas collection reservoir 312 through the sparger 308 and into the tank 312. For example, the flow rate of gas may be varied depending on the concentration of the compound to be scavenged from the gas. For example, a higher concentration of CO₂ in the gas may require a slower flow rate without altering the chemical composition of the solution in the tank 312. In some embodiments, the concentration of solution in the tank may be altered in combination with the flow rate of gas into the tank. For example, the flow rate of gas may be from 1 to 5000 gallons per minute through the sparger and into the tank. In some embodiments, the concentration of CO₂ may first be measured to determine the optimal flow rate into the system. In some embodiments, the flow rate of gas through the system may be varied following a measure of CO₂ in treated gas. For example, using methods described herein, if the concentration of CO₂ is deemed high or outside of the range for safe disposal, the flow rate may be adjusted upstream to ensure proper removal of CO₂ is occurring. In some embodiments, the reactor may further include secondary tanks in fluid communication for treating the gas mixture. For example, the system may include a slaker and a calciner. In some embodiments, the slaker may be used to rehydrate pellets that are formed in a pellet reactor. The calciner may be used for heating the pellets to release pure CO₂ that was captured in the bubble tower reactor. In some embodiments, the captured CO₂ may be used for sequestration methods or may be used for other process methods.

In some embodiments, the tank 306 may be preselected based on factors of the operation. For example, factors affecting the size of the tank used in the bubble tower may include physical and chemical properties of the subterranean formation, chemical properties of the gas extracted, expected efficiency of scavenging process, and budget of the operators of the oil field. The size of the tank may be selected based upon a quantity of liquid it is capable of holding from 100 gallons to 2000 gallons. In some embodiments, the pressure inside of the tank 306 may be controlled. For example, the pressure inside the tank 306 may be from 3 MPa to 20 MPa. By controlling the pressure inside the bubble tower reactor, the quality and stability of the bubbles generated may be controlled, allowing for increased contact time with the scavenging material and reducing the chance for foaming or coalescing of the bubbles.

In some embodiments, the scavenging material used to remove CO₂ from the water phase may be amine-based chemicals, hydroxide chemicals, such as potassium hydroxide, sodium hydroxide, lithium hydroxide, and calcium hydroxide solution. In some embodiments, the scavenging material used to remove CO₂ from the water phase may be a borate, such as sodium metaborate. In some embodiments, the chemical in the liquid may be potassium hydroxide. In some embodiments, the amines may be monoethanolamine or diethanolamine. For example, the alkanolamine may be 2-amino-2methyl-1-propanol, or N-methyldiethanolamine. In an alternate embodiment, the scavenging material may be ammonia, caustic, alcohols, or alcoholic acids.

In some embodiments, the CO₂ scavenging may be performed using metal-organic frameworks (MOF). For example, metal organic frameworks include porous solids that may have finely tunable pore surface properties. Metal organic frameworks may include Zn₄O(BDC) which consists of tetrahedral [Zn₄O]⁶⁺ clusters bridged by ditopic BDC²⁻ ligands to form a cubic, three-dimensional network. The metal organic framework may have highly tunable chemistries such that modifications to the surface chemistry of the MOF may enhance the performance of the CO₂ capturing efficiency. In some embodiments, the nano-bubbler may be used to flow a homogeneous stream of gas mixture over the MOF to provide the highest surface to surface contact between the nano bubbles and the metal organic framework. In some embodiments, the MOF's may be suspended in liquid media to enhance or improve current liquid based capture methods. In current liquid capture methods, the MOF, if added, may settle to the bottom of the contact tower, thus reducing the contact surface area and reducing efficiency. Employing MOFs is the methods described herein may allow for the MOFs to stay suspended in solution and reduce the rate at which the MOFs settle to the bottom, thus retaining the full surface area of the MOF and thereby increasing the efficiency of CO₂ capture.

In some embodiments, the concentration of the scavenging material may be increased or decreased based on the concentration of CO₂ in the gas. For example, potassium hydroxide, when unreacted, may be non-environmentally friendly when in high concentrations, while byproducts, such as calcium carbonate, may be further reacted to remove CO₂ pure gas. When the concentration of potassium hydroxide is too much in excess of the CO₂ gas, unreacted potassium hydroxide may be left in solution. In some embodiments, a desired concentration of potassium hydroxide is selected, such that after scavenging, there is minimal to no unreacted potassium hydroxide. For example, the concentration of potassium hydroxide may be from 10 grams per liter (g/L) to 200 g/L in the total solution. In some embodiments, the ratio of scavenging material to CO₂ is from 1:1 to 4:1. In some embodiments, the scavenging material is in excess by at least 25% when compared to the removal capacity of the CO₂ scavenging material for the CO₂ in the gaseous mixture or the reduced amount or concentration of CO₂ in the cleaned gaseous mixture corresponds to removal of 99% or more of the CO₂ from the gaseous mixture. In some embodiment, other chemical additives may be added to liquid. For example, buffers may be added to solution. By controlling the concentration of potassium hydroxide such that the reaction efficiency is at or near 100% and there is minimal unreacted potassium hydroxide, the cost may be significantly reduced. In some embodiments, alternate hydroxide scavenging materials may be used. For example, potassium hydroxide may be an expensive chemical, to reduce cost, the methods described herein may be employed with alternate hydroxide scavenging materials in solution.

Other bubble tower configurations may be used for scavenging from water. It may be understood by those skilled in the art that any configurations disclosed herein are provided as examples and that modifications may be made to the bubble tower reactor, as shown for example, to further improve efficiency removal. In some embodiments, the bubble reactor system employed may have an inlet valve located at the top of the tower for injecting liquid into the bubble tower. The inlet positioned at the top of the tower may have a control valve for increasing or decreasing the flow of liquid into the tower. For example, the flow of water into the tower from above may be from 1 gallon per minute (GPM) to 100 GPM. In some embodiments, the flow of water into the tower may be varied in parallel with the gas inlet flow such that the pressure of water flowing into the tower collides with the bubbles rising through the tower and the collision of the two pressures cause the bubbles to decrease in rising speed or come to a halt thereby increasing contact time within the solution. In an alternate embodiment, the gas may rise to the surface of the tower whereby an outlet valve may be located. The outlet valve may allow for gas to flow into the base of a second bubble tower reactor whereby the gas may react a second time in a new solution to further remove CO₂. Alternate configurations may be employed. For example, the scavenging system may include a contact tower connected to a separator tower, the separator tower may be in fluid communication with a tank for collecting spent chemical liquid. The contact tower may be in fluid communication with a second tank for holding fresh or clean chemical solution. Pumps may be in line connected between the fresh tank inlet and the contact tower. The contact tower may include the sparger, such as the nano-bubbler. In some cases, fluids (liquids and gases) may be recirculated back into the contact tower after for repeated scavenging, if desired.

In some embodiments, the sparger 308 may be selected such that the sparger is a nano-bubbler. A nano-bubbler may be known as a sparger system that produced nano-bubbles. For example, the nanobubbles produced from a nano-bubbler may be from 1 nm to 1000 nm in diameter. The nano-bubbles may increase surface area of the CO₂ gas for contact with the scavenging material. For example, nano materials may have a much larger surface-to-volume ratio when compared to other macromolecules. By injecting nano bubbles into the system, the surface area of bubble to solution may be increased. In some embodiments, the sparger 208 that is the nano-bubbler may be controlled to change the size of the nano bubbles. The nano bubble may be a homogenous size, or within ±10 nm of one another. For example, the nano bubbles may be from 10 nm to 20 nm, from 20 nm to 30 nm, from 30 nm to 40 nm, from 40 nm to 50 nm, from 50 nm to 60 nm, from 60 nm to 70 nm, from 70 nm to 80 nm, from 80 nm to 90 nm, from 90 nm to 100 nm, up to 1000 nm in 10 nm increments. The sparger may be used to direct the nanobubbles in a travel direction counter to a flow direction of the liquid. The flow rate of the gas through the sparger and of the liquid may be controllable to adjust the retention time of the nanobubbles in the liquid.

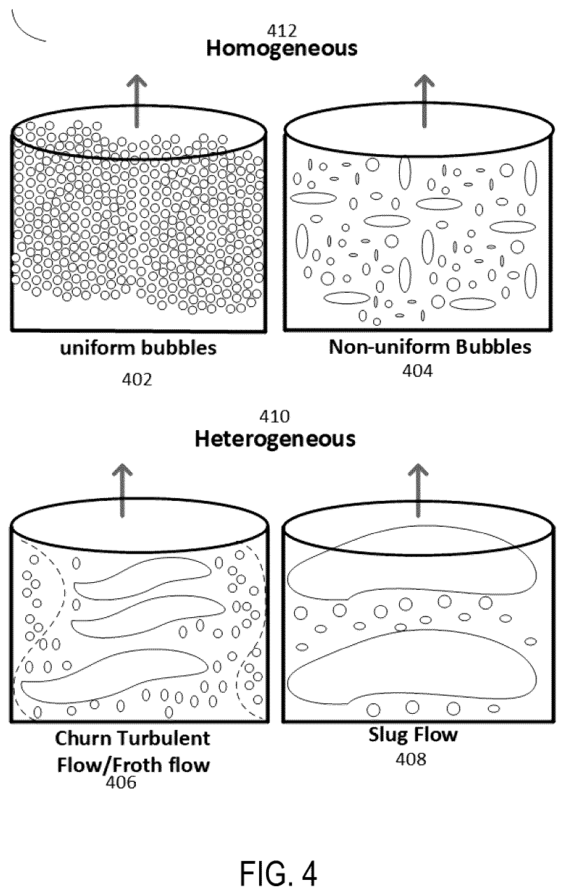

FIG. 4 provides example schematics 400 of the bubbles produced in a bubble tower reactor according to one example of the present disclosure. In some embodiments, common bubble tower reactors produce bubbles that may be non-uniform or inconsistent. For example, the bubbles may be heterogeneous 410. Heterogeneous bubbles may cause imperfect or bad bubbles. The imperfect bubble creation may reduce efficiency of scavenging. In some embodiments, the heterogeneous bubbles may cause churn turbulent 406. Churn turbulent may refer to a two-phase gas/liquid flow regime characterized by a highly-agitated flow where gas bubbles may be sufficient in numbers to both interact with each other and, while interacting, coalesce to form larger distorted bubbles with unique shapes and behaviors in the system. Churn turbulent flow may be created when there is a large gas fraction in a system with a high gas and low liquid velocity. In bubble towers, churn turbulent may be insufficient for removal of CO₂ gas. In some embodiments, the heterogeneous flow of gas created by the sparger may be a slug flow 408. Slug flow may refer to a gas flow in a bubble tower that causes large pockets of gas bubbles to separate large pockets of liquid, thus creating less surface area of contact between the liquid including the scavenging material and the CO₂ gas. Typical spargers may be capable of producing homogeneous 412 bubbles however, they may be imperfect or bad bubbles 404. These bad bubbles may result in inadequate scavenging. In some embodiments, the sparger described above and in FIG. 3 may be used to create a more uniform flow of gas bubbles in the bubble tower reactor. In some embodiments, the nano-bubbler may create a flow of bubbles that do not generate a foam in the solution, providing a clean and efficient source of bubbles in the bubble tower reactor.

The sparger 308, in FIG. 3, may be a nano-bubbler for producing bubbles that may be referred to as perfect bubbles 402. Perfect bubbles may be used to describe the homogeneous 412 production of bubbles in the bubble tower. The homogeneous bubbles may be nanoparticle sized. For example, the bubbles produced in the nano bubbler may be from 1 nm to 1000 nm as described above. The gas collected may be further injected with a carrier gas for transporting, through the flowlines, the gaseous mixture including CO₂. In some embodiments, the carrier gas may be an exhaust gas or a natural gas, for example, methane or other hydrocarbon gas. For example, the carrier gas may be a fuel gas, or an exhaust gas such as ethane streams. In an alternate embodiment, the carrier gas may be a gas supply that is non-reactive with the presence of oxidizers. In some embodiments, the non-reactive gases may include argon, carbon dioxide, helium, and nitrogen gas. The non-reactive gas may be injected into the gaseous mixture to aid in transporting the gas mixture to the holding tank or directly to the bubble tower reactor.

In some aspects, methods and systems for improving scavenging efficiency of CO₂ in reactors, for example reactors used in oilfield operations, are provided according to one or more of the following examples. As used below, any reference to a series of examples is to be understood as a reference to each of those examples disjunctively (e.g., “Examples 1-4” is to be understood as “Examples 1, 2, 3, or 4”).

Example 1 is a method for scavenging carbon dioxide generated during wellbore, hydrocarbon production, or combustion operations, the method comprising: collecting a gaseous mixture generated during a oilfield operation, a hydrocarbon production operation, or a combustion operation, wherein the gaseous mixture comprises CO2; injecting the gaseous mixture into a liquid as a plurality of nanobubbles, wherein the liquid comprises a CO2 scavenging material that interacts with the nanobubbles and removes CO2 from the nanobubbles; and outputting a cleaned gaseous mixture containing a reduced amount or concentration of CO2 compared to the gaseous mixture and a carbon-rich liquid.

Example 2 is the method of example 1, wherein the nanobubbles are of a controlled size ranging from 1 nm to 1000 nm in diameter.

Example 3 is the method of any one of examples 1-2, wherein injecting the gaseous mixture is performed at a flow rate of from 1 to 5000 gallons per minute.

Example 4 is the method of any one of examples 1-3, wherein the gascous mixture is injected into the liquid in combination with a carrier liquid or a carrier.

Example 5 is the method of example 4, wherein the carrier gas is an exhaust gas, a hydrocarbon gas, or an inert gas.

Example 6 is the method of any one of examples 1-5, wherein the scavenging material comprises an alkali metal hydroxide, and wherein a concentration of the CO2 scavenging material is from 1 wt. % to 30 wt. % by weight of solution.

Example 7 is the method of any one of examples 1-6, wherein injecting the gaseous mixture into the liquid occurs as a batch operation or a continuous operation.

Example 8 is the method of any one of examples 1-7, wherein a concentration of the CO2 scavenging material in the liquid is in excess by at least 25% as compared to a removal capacity of the CO2 scavenging material for the CO2 in the gaseous mixture, or wherein the reduced amount or concentration of CO2 in the cleaned gaseous mixture corresponds to removal of 99% more of the CO2 from the gaseous mixture.

Example 9 is the method of any one of examples 1-8, further comprising analyzing the cleaned gaseous mixture and modifying a composition or condition of the liquid or gaseous mixture to adjust an amount or concentration of CO2 in the cleaned gaseous mixture.

Example 10 is the method of example 9, wherein modifying comprises one or more of: adjusting a temperature of the liquid or the gaseous mixture; or adjusting a pressure of the liquid or the gaseous mixture; or adjusting an amount or concentration of the CO2 scavenging material in the liquid; or adjusting a flow rate of the liquid or the gaseous mixture.

Example 11 is the method of any one of examples 1-10, wherein injecting the gaseous mixture comprises injecting the gaseous mixture in a bubble reactor tower or wherein injecting the gaseous mixture comprises injecting the gaseous mixture using direct injection into a pipeline or flowline.

Example 12 is the method of any one of examples 1-11, further comprising: transferring the carbon-rich liquid to a reactor to generate pellets comprising a metal carbonate; and outputting the pellets comprising the metal carbonate.

Example 13 is a system comprising: a fluid containment or flow system at least partially filled with a liquid comprising a CO2 scavenging material; an inlet coupled to a sparger within the fluid containment or flow system for injecting a gaseous mixture comprising CO2 into the liquid as a plurality of nanobubbles, wherein the CO2 scavenging material is configured to interact with the nanobubbles to remove CO2 from the nanobubbles and generate a cleaned gaseous mixture containing a reduced amount of CO2 compared to the gaseous mixture; at least one outlet within the fluid containment or flow system for removing the cleaned gaseous mixture.

Example 14 is the system of example 13, wherein the sparger is configured for controllably producing nanobubbles ranging from 1 nm to 1000 nm in diameter.

Example 15 is the system of any one of examples 13-14, wherein the fluid containment or flow system comprises a bubble tower or a pipeline or flowline.

Example 16 is the system of any one of examples 13-15, further comprising one or more sensors for monitoring a first characteristic of the liquid or the gaseous mixture and one or more controllers for controlling a second characteristic of the liquid or the gaseous mixture, wherein characteristics of the liquid or gaseous mixture include one or more of a temperature, a pressure, a flow rate, a concentration of a salt, a concentration of H2S, a concentration of the H2S scavenging material, a concentration of a contaminant, or a concentration of a reaction product for reaction between H2S and the H2S scavenging material.

Example 17 is the system of any one of examples 13-16, wherein the gas mixture is generated during a wellbore operation, a hydrocarbon production operation, or a combustion operation.

Example 18 is the system of any one of examples 13-17, wherein the CO2 scavenging material is an alkali metal hydroxide, and wherein a concentration of the CO2 scavenging material in the liquid is from 1 wt. % to 30 wt. % by weight of solution.

Example 19 is the system of any one of examples 13-18, wherein the sparger is arranged to direct the nanobubbles in a travel direction counter to a flow direction of the liquid and wherein flow rates of the liquid and the gaseous mixture in the fluid containment or flow system are controllable to adjust a retention time of the nanobubbles in the liquid.

Example 20 is the system of any one of examples 13-19, wherein a concentration of the CO2 scavenging material in the liquid is in excess by or at least 25% as compared to a removal capacity of the CO2 scavenging material for the CO2 in the gaseous mixture.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A method for scavenging carbon dioxide generated during wellbore, hydrocarbon production, or combustion operations, the method comprising:
collecting a gaseous mixture generated during a oilfield operation, a hydrocarbon production operation, or a combustion operation, wherein the gaseous mixture comprises CO₂;
injecting the gaseous mixture into a liquid as a plurality of nanobubbles, wherein the liquid comprises a CO₂ scavenging material that interacts with the nanobubbles and removes CO₂ from the nanobubbles; and
outputting a cleaned gaseous mixture containing a reduced amount or concentration of CO₂ compared to the gaseous mixture and a carbon-rich liquid.

2. The method of claim 1, wherein the nanobubbles are of a controlled size ranging from 1 nm to 1000 nm in diameter.

3. The method of claim 1, wherein injecting the gaseous mixture is performed at a flow rate of from 1 to 5000 gallons per minute.

4. The method of claim 1, wherein the gaseous mixture is injected into the liquid in combination with a carrier liquid or a carrier gas.

5. The method of claim 4, wherein the carrier gas is an exhaust gas, a hydrocarbon gas, or an inert gas.

6. The method of claim 1, wherein the scavenging material comprises an alkali metal hydroxide, and wherein a concentration of the CO2 scavenging material is from 1 wt. % to 30 wt. % by weight of solution.

7. The method of claim 1, wherein injecting the gaseous mixture into the liquid occurs as a batch operation or a continuous operation.

8. The method of claim 1, wherein a concentration of the CO₂ scavenging material in the liquid is in excess by at least 25% as compared to a removal capacity of the CO₂ scavenging material for the CO₂ in the gaseous mixture, or wherein the reduced amount or concentration of CO₂ in the cleaned gaseous mixture corresponds to removal of 99% more of the CO₂ from the gaseous mixture.

9. The method of claim 1, further comprising analyzing the cleaned gaseous mixture and modifying a composition or condition of the liquid or gaseous mixture to adjust an amount or concentration of CO₂ in the cleaned gaseous mixture.

10. The method of claim 9, wherein modifying comprises one or more of:
adjusting a temperature of the liquid or the gaseous mixture; or
adjusting a pressure of the liquid or the gaseous mixture; or
adjusting an amount or concentration of the CO2 scavenging material in the liquid; or
adjusting a flow rate of the liquid or the gaseous mixture.

11. The method of claim 1, wherein injecting the gaseous mixture comprises injecting the gaseous mixture in a bubble reactor tower or wherein injecting the gaseous mixture comprises injecting the gaseous mixture using direct injection into a pipeline or flowline.

12. The method of claim 1, further comprising:
transferring the carbon-rich liquid to a reactor to generate pellets comprising a metal carbonate; and
outputting the pellets comprising the metal carbonate.

13. A system comprising:
a fluid containment or flow system at least partially filled with a liquid comprising a CO2 scavenging material;
an inlet coupled to a sparger within the fluid containment or flow system for injecting a gaseous mixture comprising CO2 into the liquid as a plurality of nanobubbles, wherein the CO2 scavenging material is configured to interact with the nanobubbles to remove CO2 from the nanobubbles and generate a cleaned gaseous mixture containing a reduced amount of CO2 compared to the gaseous mixture;
at least one outlet within the fluid containment or flow system for removing the cleaned gaseous mixture.

14. The system of claim 13, wherein the sparger is configured for controllably producing nanobubbles ranging from 1 nm to 1000 nm in diameter.

15. The system of claim 13, wherein the fluid containment or flow system comprises a bubble tower or a pipeline or flowline.

16. The system of claim 13, further comprising one or more sensors for monitoring a first characteristic of the liquid or the gaseous mixture and one or more controllers for controlling a second characteristic of the liquid or the gaseous mixture, wherein characteristics of the liquid or gaseous mixture include one or more of a temperature, a pressure, a flow rate, a concentration of a salt, a concentration of H2S, a concentration of the H2S scavenging material, a concentration of a contaminant, or a concentration of a reaction product for reaction between H2S and the H2S scavenging material.

17. The system of claim 13, wherein the gas mixture is generated during a wellbore operation, a hydrocarbon production operation, or a combustion operation.

18. The system of claim 13, wherein the CO₂ scavenging material is an alkali metal hydroxide, and wherein a concentration of the CO2 scavenging material in the liquid is from 1 wt. % to 30 wt. % by weight of solution.

19. The system of claim 13, wherein the sparger is arranged to direct the nanobubbles in a travel direction counter to a flow direction of the liquid and wherein flow rates of the liquid and the gaseous mixture in the fluid containment or flow system are controllable to adjust a retention time of the nanobubbles in the liquid.

20. The system of claim 13, wherein a concentration of the CO₂ scavenging material in the liquid is in excess by or at least 25% as compared to a removal capacity of the CO₂ scavenging material for the CO₂ in the gaseous mixture.
